(19) United States
(12) Patent Application Publication
(10) Pub. No.: US 2007/0014253 A1
(43) Pub. Date: Jan. 18, 2007

(54) Wireless channel searching method, wireless transmitting/receiving system and wireless transmitting apparatus

(75) Inventors: Bong-geun Lee, Suwon-si (KR); Kab-keun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/397,718

(22) Filed: Apr. 5, 2006

(30) Foreign Application Priority Data
Jul. 18, 2005 (KR) 2005-0064897

(51) Int. Cl. H04J 4/00; H04J 1/00; H04J 3/22; H04J 3/16; H04B 7/00; H04B 7/14; H04J 3/08; H04J 1/10

(52) U.S. Cl. 370/315; 370/310; 370/465; 370/436; 370/343

(57) ABSTRACT

The present invention relates to a method of searching a wireless channel by searching unused wireless channels. A list of the searched unused wireless channels is stored. A multimedia signal transmitted and received through one of the unused wireless channels. Thus, a wireless channel searching method, a wireless transmitting/receiving system and a wireless transmitting apparatus of the present invention, quickly change a wireless transmitting channel into other usable channels, if interference occurs in a wireless transmitting channel.

### CROSS-REFERENCE TO RELATED APPLICATIONS

This application claims the benefit under 35 U.S.C. §119(a) of Korean Patent Application No. 2005-0064897, filed on Jul. 18, 2005, in the Korean Intellectual Property Office, the entire disclosure of which is hereby incorporated by reference.

### BACKGROUND OF THE INVENTION

1. Field of the Invention

The present invention relates to a wireless channel searching method, a wireless transmitting/receiving system and a wireless transmitting apparatus. More particularly, the present invention relates to a wireless channel searching method, a wireless transmitting/receiving system and a wireless transmitting apparatus, which changes a wireless frequency that transmits and receives a wireless multimedia signal, that is, a wireless channel.

2. Description of the Related Art

Wireless transmitting/receiving systems are widely used, which makes various apparatuses communicate wirelessly with each other in a limited area. A wireless transmitting/receiving system transmits and receives a predetermined multimedia signal through a predetermined wireless frequency, that is, a wireless channel.

Since the number of wireless channels is limited, interference may occur if other electronic apparatuses use a wireless channel that is also being used by the wireless transmitting/receiving system, or if a neighboring wireless channel is used.

A conventional wireless transmitting/receiving system checks the wireless channels and searches unused channels, if interference occurs in a wireless transmitting channel while it transmits and receives the multimedia signal through a predetermined wireless transmitting channel.

If the conventional wireless transmitting/receiving system transmits and receives a multimedia signal in real time, similarly to how a television receives a multimedia signal, pictures are displayed abnormally while transmittable wireless channels are searched.

Accordingly, there is a need for an improved wireless transmitting/receiving system that transmits and receives multimedia signals and searches for unused wireless channels.

### SUMMARY OF THE INVENTION

An aspect of embodiments of the present invention is to address at least the above problems and/or disadvantages and to provide at least the advantages described below. Accordingly, an aspect of embodiments of the present invention is to provide a wireless channel searching method, a wireless transmitting/receiving system and a wireless transmitting apparatus to quickly change a wireless transmitting channel into other usable channels if interference occurs in a wireless transmitting channel.

Additional aspects and/or advantages of an exemplary embodiment of the present invention will be set forth in part in the description which follows and, in part, will be obvious from the description, or may be learned by practice of the present invention.

The foregoing and/or other aspects of an exemplary embodiment of the present invention are also achieved by providing a method of searching a wireless channel, which includes unused wireless channels that are searched. A list of the unused wireless channels, which are searched, is stored. A multimedia signal is transmitted and received through one of the unused wireless channels.

According to another exemplary embodiment of the present invention, the method further includes a transmitted amount of the multimedia signal and a preset reference level that are compared. The list of the unused wireless channels is renewed, if a determination is made that the transmitted amount of the multimedia signal is lower than the reference level.

According to still another exemplary embodiment of the present invention, the method further includes the wireless channel changed into one channel in the list of the unused wireless channels and the multimedia signal is transmitted and received through the changed wireless channel, if a determination is made that interference occurs between the wireless channel transmitting and receiving the multimedia signal, and an additional wireless channel.

According to a further exemplary embodiment of the present invention, the method further includes the list of the unused wireless channels is renewed when the wireless channel is not stored in the list of the unused wireless channels, if a determination is made that interference occurs between the wireless channel receiving the multimedia signal and the additional wireless channel.

The foregoing and/or other aspects of an exemplary embodiment of the present invention are also achieved by providing a wireless transmitting/receiving system, including a wireless transmitting apparatus having a transmission interface that transmits a multimedia signal wirelessly, and a transmission controller that stores a list of unused wireless channels by searching wireless channels through which the multimedia signal can be transmitted, and controls the transmission interface to transmit the multimedia signal through one wireless channel in the list of the unused wireless channels. A wireless receiving apparatus having a reception interface receives the multimedia signal from the wireless transmitting apparatus, an output unit outputs the multimedia signal and a reception controller controls the output unit to output the multimedia signal.

According to another exemplary embodiment of the present invention, the reception controller transmits a predetermined communication signal to the wireless transmitting apparatus, if a determination is made that a transmitted amount of the multimedia signal is lower than a preset reference level, and the transmission controller renews the list of the unused wireless channels, if it receives the communication signal.

According to still another exemplary embodiment of the present invention, the transmission controller renews the list of the unused wireless channels, if a determination is made that the transmitted amount of the multimedia signal is lower than the preset reference level.

According to a further exemplary embodiment of the present invention, the reception controller transmits the predetermined communication signal to the wireless transmitting apparatus, if a determination is made that interference occurs between the wireless channel transmitting and receiving the multimedia signal and an additional wireless channel, and the transmission controller changes the wireless channel into one channel in the list of the unused wireless channels, and controls the transmission interface to transmit the multimedia signal through the changed wireless channel, if it receives the communication signal.

According to another exemplary embodiment of the present invention, the transmission controller renews the list of the unused wireless channels, if the wireless channel is not stored in the list of the unused wireless channels, when it receives the communication signal.

According to still another exemplary embodiment of the present invention, the transmission controller controls the transmission interface to change the wireless channel into one channel in the list of the unused wireless channels and to transmit the multimedia signal through the changed wireless channel, if a determination is made that interference occurs between the wireless channel transmitting and receiving the multimedia signal and an additional wireless channel.

According to a further exemplary embodiment of the present invention, the transmission controller renews the list of the unused wireless channels, if the wireless channel is not stored in the list of the unused wireless channels.

The foregoing and/or other aspects of an exemplary embodiment of the present invention are also achieved by providing a wireless transmitting apparatus, included a transmission interface that transmits a multimedia signal wirelessly, and a controller that stores a list of unused wireless channels by searching wireless channels through which the multimedia signal can be transmitted and controls the transmission interface to transmit the multimedia signal through one wireless channel in the list of the unused wireless channels.

According to yet another exemplary embodiment of the present invention, the transmission controller renews the list of the unused wireless channels, if it a determination is made that a transmitted amount of the multimedia signal is lower than a preset reference level.

Other objects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a control block diagram of a wireless transmitting/receiving system according to an exemplary embodiment of the present invention;

FIG. 2 illustrates the transmitted amount of a wireless multimedia signal according to an exemplary embodiment of the present invention; and

FIG. 3 is a control flowchart of the wireless transmitting/receiving system according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

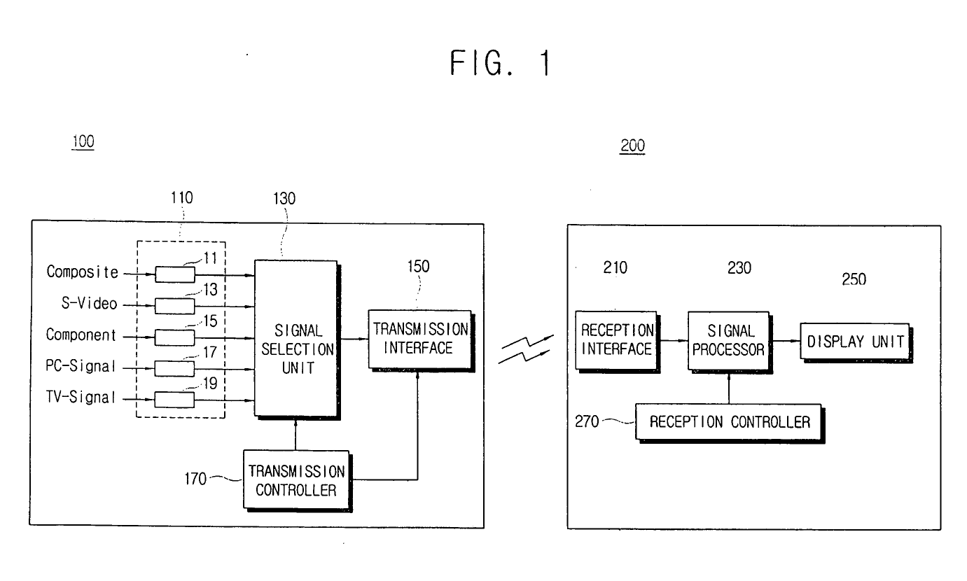

As shown in FIG. 1, a wireless transmitting/receiving system according to an exemplary embodiment of the present invention comprises a wireless transmitting apparatus 100 to transmit a multimedia signal, and a wireless receiving apparatus 200 to receive the multimedia signal output from the wireless transmitting apparatus 100.

The wireless transmitting/receiving system transmits and receives the multimedia signal wirelessly. For example, the wireless transmitting/receiving system may include a display system in which a tuner receiving the multimedia signal and a display unit 250 displaying the received multimedia signal transmit and receive the multimedia signal with each other wirelessly. A mobile phone system is included in the wireless transmitting/receiving system in which a mobile phone and ear phone, receiving the multimedia signal from the mobile phone, transmit and receives the multimedia signal with each other wirelessly. A computer system is also included in which a computer and speaker, receiving the multimedia signal from the computer, transmit and receive the multimedia signal with each other wirelessly. A configuration of the wireless transmitting/receiving system is not limited as long as the configuration transmits and receives the multimedia signal wirelessly.

Hereinafter, a display system will be described as an example of the wireless transmitting/receiving system according to an exemplary embodiment of the present invention.

As described above, the display system according to an exemplary embodiment of the present invention comprises the wireless transmitting apparatus 100 and the wireless receiving apparatus 200.

The wireless transmitting apparatus 100 comprises a signal input unit 110 to receive a predetermined multimedia signal; a signal selection unit 130 to output the multimedia signal to be output to the wireless receiving apparatus 200 among the input multimedia signals; a transmission interface 150 to output the multimedia signal; and a transmission controller 170 to control the foregoing elements.

The signal input unit 110 may comprise terminals corresponding to various image signal formats, to receive image signals in various formats.

That is, the signal input unit 110 may comprise a composite input terminal 11 to receive a composite signal; a S-video input terminal 13 to receive a S-video signal; a component input terminal 15 to receive a component signal; a PC input terminal 17 to receive a PC signal; and a TV input terminal 19 to receive a TV signal.

Here, the signal input unit 110 comprises a tuner to select a TV signal transmitted from a broadcasting station.

The signal selection unit 130 selects the multimedia signal to be output through the output unit, for example, through the display unit 250, among a plurality of multimedia signals input through a plurality of input terminals provided in the signal input unit 110. At this time, the signal selection unit 130 preferably includes a multiplexer to output one of the plurality of input multimedia signals, but not limited thereto.

The transmission interface 150 outputs the multimedia signal to the wireless receiving apparatus 200. The transmission interface 150 may transmit and receive a predetermined communication signal, with respect to a reception interface 210 (to be described later). Here, the transmission interface 150 may wirelessly communicate with the reception interface 210 through RF communication or bluetooth.

The transmission controller 170 may control the signal selection unit 130 to select one of the plurality of multimedia signals. The transmission controller 170 may control the signal selection unit 130 through a predetermined program. However, it is preferable, but not necessary, that the transmission controller 170 controls the signal selection unit 130 through a selection signal output from a user input unit (not shown).

The transmission controller 170 controls the transmission interface 150 to output the multimedia signal through the predetermined wireless channel. At this time, the transmission controller 170 searches wireless channels among overall usable wireless channels, which are not used by other devices. After searching the unused wireless channels, the transmission controller 170 may transmit the multimedia signal through one of the unused wireless channels.

For example, if a frequency for the wireless communication is 0-200 MHz and each channel is given 20 MHz for the wireless communication, 10 wireless channels including 0-20 MHz, 20 MHz-40 MHz, 40-60 MHz, and the like, may be given.

The transmission controller 170 then determines the state of the respective wireless channels to check whether an additional wireless transmitting/receiving system communicates through the wireless channel. For example, the transmission controller 170 determines the transmitted amount of the multimedia signal transmitted and received through the wireless channel. If the transmitted amount of the multimedia signal is larger than a predetermined reference level, the transmission controller 170 determines that the additional wireless transmitting/receiving system uses the corresponding wireless channel. Here, the transmission controller 170 determines whether the respective wireless channels are used, and stores a list of wireless channels which are not used.

The foregoing reference level may be adjusted since interference may occur between the unused wireless channels and an adjacent wireless channel, and the multimedia signal may generate an error.

The transmission controller 170 may compare the transmitted amount of the multimedia signal and a preset transmission level, which is higher than the reference level, while it transmits the multimedia signal through the wireless channel. At this time, the transmission controller 170 searches the unused wireless channels again to renew the list of unused wireless channels, if the transmitted amount of the multimedia signal is lower than the preset transmission level.

If the transmission controller 170 determines that interference occurs in the wireless transmitting channel transmitting the multimedia signal, the transmission controller 170 may change the wireless transmitting channel into one wireless channel in the stored list of unused wireless channels. The transmission controller 170 also controls the transmission interface 150 to output the multimedia signal to the wireless receiving apparatus 200 through the changed wireless transmitting channel. Here, an interference includes what other apparatuses attempt to communicate through the wireless transmitting channel, or noise generated by interference between neighboring wireless channels.

If the transmission controller 170 determines that interference occurs in the wireless transmitting channel transmitting the multimedia signal, the transmission controller 170 searches the list of the unused wireless channels. If the list is not stored or the usable wireless channels are not in the list, the transmission controller 170 may search the wireless channels again, and store the list of the unused wireless channels according to a searching result. The transmission controller 170 may control the transmission interface 150 to transmit the multimedia signal through one channel of the stored list of the unused wireless channels.

The wireless receiving apparatus 200 includes the reception interface 210 to receive the multimedia signal from the transmission interface 150 of the wireless transmitting apparatus 100; a signal processor 230 to process the received multimedia signal; an output unit to output the multimedia signal processed by the signal processor 230; and a reception controller 270 to control the foregoing elements.

The reception interface 210 receives the multimedia signal from the transmission interface 150. Also, the reception interface 210 transmits and receives a predetermined communication signal, by communicating with the transmission interface 150.

The signal processor 230 processes the multimedia signal to be output by the output unit. At this time, the signal processor 230 may comprise an audio processor, if the multimedia signal comprises an audio signal, and an image signal processor, if the multimedia signal comprises an image signal, according to the type of the multimedia signal.

The output unit outputs the signal processed by the signal processor 230. If the wireless receiving apparatus 200 is provided as a display apparatus, the output unit comprises a display unit 250. If the wireless receiving apparatus 200 is provided as an audio output apparatus, the output unit may comprise a speaker or an earphone. As described above, the display unit 250 will be described as an example of the output unit according to the present invention.

The reception controller 270 controls respective parts to display the multimedia signal on the display unit 250, if the reception controller 270 determines that the reception interface 210 receives the multimedia signal from the wireless transmitting apparatus 100.

Like the transmission controller 170, the reception controller 270 may search the list of unreceived wireless channels and store the list. Also, the reception controller 270 may determine the transmitted amount of the received multimedia signal and renew the list of unreceived wireless channels, if the transmitted amount is lower than the predetermined reference level. The reception controller 270 may determine whether interference occurs in the wireless transmitting channel, and change the wireless transmitting channel, according to a determination result, or renew the list of the unreceived wireless channels. At least one of the reception controller 270 or the transmission controller 170 may perform the operations described above. That is, in the foregoing exemplary embodiments, the transmission controller 170 performs the foregoing operations, but is not limited thereto. Instead, the reception controller 270 may perform the foregoing operations.

For example, the transmission controller 170 may store the list of unused wireless channels. The reception controller 270 may determine the transmitted amount of the multimedia signal received through the wireless transmitting channel and output the communication signal to the wireless transmitting apparatus 100, which comprises information that the transmitted amount is lower than the reference level, if the transmitted amount is lower than the predetermined reference level. At this time, the transmission controller 170 may renew the list of unused wireless channels, if it receives the communication signal.

If the reception controller 270 determines that predetermined interference occurs, the reception controller 270 may output the communication signal to the transmission interface 150, which comprises information of the interference. The transmission controller 170 may change the wireless transmitting channel or renew the list of unused wireless channels if the transmission controller 170 receives the communication signal. Here, the reception controller 270 may determine whether predetermined interference occurs in header information of the received multimedia signal, or a signal noise ratio (SNR).

At least one of the reception controller 270 or the transmission controller 170 may be designed to perform the foregoing respective operations, and a programmer may determine by which the operations are performed.

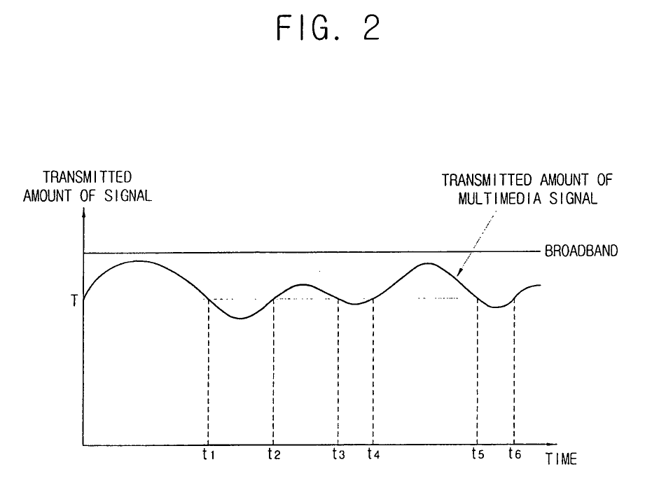

As shown in FIG. 2, the transmission interface 150 and the reception interface 210 may transmit and receive the signal with each other in a predetermined bandwidth range through the wireless transmitting channel.

At this time, the transmitted amount of the multimedia signal is not always identical, and it may vary within the predetermined bandwidth range. Data may be transmitted and received through the wireless transmitting channel, in an amount that is a difference between the bandwidth and the transmitted amount of the multimedia signal.

At least one of the transmission controller 170 or the reception controller 270 determines whether the transmitted amount of the multimedia signal is lower than the reference level T and renews the list of unused wireless channels in areas t1˜t2, t3˜t4 and t5˜t6, where the transmitted amount is lower than the reference level.

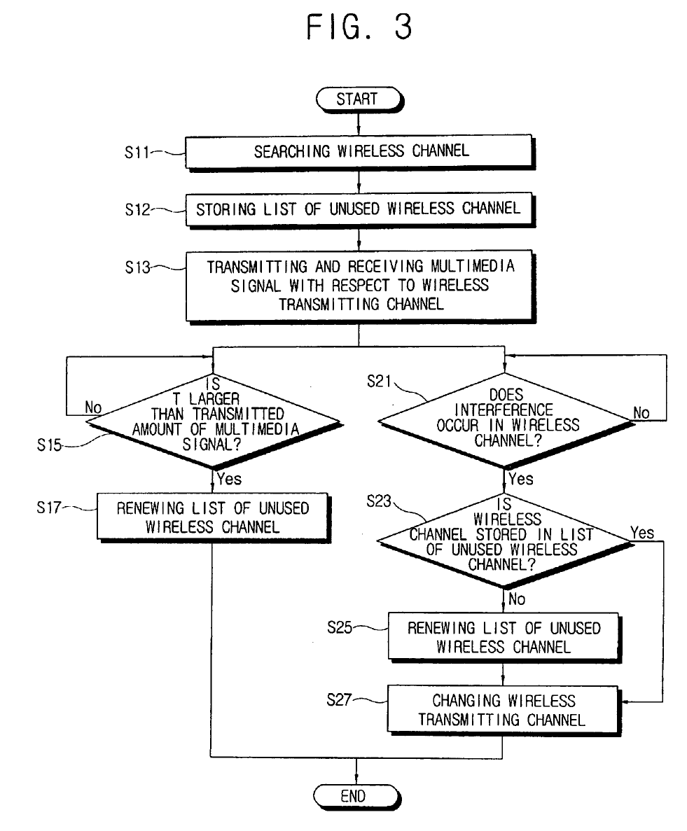

As shown in FIG. 3, the wireless transmitting/receiving system, according to an exemplary embodiment of the present invention, searches the usable wireless channels at operation S11. After the usable wireless channels are searched, the additional wireless transmitting/receiving system stores the list of unused wireless channels at operation S12. The wireless transmitting/receiving system, according to an exemplary embodiment of the present invention, selects one of the unused wireless channels as the wireless transmitting channel to transmit and receive the multimedia signal with respect to the selected wireless transmitting channel at operation S13.

Here, if the transmitted amount of the multimedia signal is lower than the reference level T at operation S15, the wireless transmitting/receiving system may renew the list of unused wireless channels at operation S17.

Meanwhile, if interference occurs between the wireless transmitting channel that transmits and receives the multimedia signal and the additional wireless channel, or external noise is generated at operation S21, the wireless transmitting/receiving system determines whether a predetermined channel is stored in the list of unused wireless channels at operation S23. If the usable wireless channel is stored, the wireless transmitting/receiving system changes the wireless transmitting channel to transmit and receive the multimedia signal through the changed wireless transmitting channel. If the usable wireless channel is not stored, the wireless transmitting/receiving system renews the list of unused wireless channels at operation S25, and changes the wireless transmitting channel by selecting one channel in the list of the renewed unused wireless channels at operation S27.

In the foregoing exemplary embodiments, the wireless transmitting apparatus 100 comprises the input terminal of the multimedia signal supplied from outside the wireless transmitting apparatus. Alternatively, the wireless transmitting apparatus 100 may include the signal processor 230 in order to display the multimedia signal input through the input terminal on the display unit 250.

As described above, the wireless transmitting/receiving system, according to an exemplary embodiment of the present invention stores the list of the unused wireless channels to quickly change the wireless transmitting channel into one channel stored in the list of the unused wireless channels. As a result, the transmitting/receiving system does not search the transmittable wireless transmitting channels, like in the conventional wireless transmitting/receiving system, in a case interference occurs in the wireless transmitting channel.

Also, the wireless transmitting/receiving system according to an exemplary embodiment of the present invention may efficiently renew the list of unused wireless channels, if the transmitted amount of the signals is small.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of searching a wireless channel, comprising:
searching unused wireless channels;
storing a list of the unused wireless channels, which are searched; and
transmitting and receiving a multimedia signal through one of the unused wireless channels.

2. The method according to claim 1, further comprising:
comparing a transmitted amount of the multimedia signal and a preset reference level; and
renewing the list of the unused wireless channels, if a determination is made that the transmitted amount of the multimedia signal is lower than the reference level.

3. The method according to claim 1, further comprising:
changing the wireless channel into one channel in the list of the unused wireless channels, and transmitting and receiving the multimedia signal through the changed wireless channel, if a determination is made that interference occurs between the wireless channel transmitting and receiving the multimedia signal, and an additional wireless channel.

4. The method according to claim 3, further comprising:
renewing the list of the unused wireless channels when the wireless channel is not stored in the list of the unused wireless channels, if a determination is made that interference occurs between the wireless channel receiving the multimedia signal and the additional wireless channel.

5. A wireless transmitting/receiving system, comprising:
a wireless transmitting apparatus having a transmission interface for transmitting a multimedia signal wirelessly, and a transmission controller for storing a list of unused wireless channels by searching wireless channels through which the multimedia signal can be transmitted, and controlling the transmission interface to transmit the multimedia signal through one wireless channel in the list of the unused wireless channels; and
a wireless receiving apparatus having a reception interface for receiving the multimedia signal from the wireless transmitting apparatus, an output unit for outputting the multimedia signal, and a reception controller for controlling the output unit to output the multimedia signal.

6. The system according to the claim 5, wherein the reception controller transmits a predetermined communication signal to the wireless transmitting apparatus, if a determination is made that a transmitted amount of the multimedia signal is lower than a preset reference level, and the transmission controller renews the list of the unused wireless channels, if it receives the communication signal.

7. The system according to claim 5, wherein the transmission controller renews the list of the unused wireless channels, if a determination is made that the transmitted amount of the multimedia signal is lower than the preset reference level.

8. The system according to claim 5, wherein the reception controller transmits the predetermined communication signal to the wireless transmitting apparatus, if a determination is made that interference occurs between the wireless channel transmitting and receiving the multimedia signal and an additional wireless channel, and the transmission controller changes the wireless channel into one channel in the list of the unused wireless channels and controls the transmission interface to transmit the multimedia signal through the changed wireless channel, if it receives the communication signal.

9. The system according to claim 8, wherein the transmission controller renews the list of the unused wireless channels, if the wireless channel is not stored in the list of the unused wireless channels, when it receives the communication signal.

10. The system according to claim 5, wherein the transmission controller controls the transmission interface to change the wireless channel into one channel in the list of the unused wireless channels and to transmit the multimedia signal through the changed wireless channel, if a determination is made that interference occurs between the wireless channel transmitting and receiving the multimedia signal and an additional wireless channel.

11. The system according to claim 10, wherein the transmission controller renews the list of the unused wireless channels, if the wireless channel is not stored in the list of the unused wireless channels.

12. A wireless transmitting apparatus, comprising:
a transmission interface for transmitting a multimedia signal wirelessly; and
a controller for storing a list of unused wireless channels by searching wireless channels through which the multimedia signal can be transmitted and controlling the transmission interface to transmit the multimedia signal through one wireless channel in the list of the unused wireless channels.

13. The apparatus according to claim 12, wherein the transmission controller renews the list of the unused wireless channels, if a determination is made that a transmitted amount of the multimedia signal is lower than a preset reference level.
